(19) United States
(12) Patent Application Publication
(10) Pub. No.: US 2007/0074278 A1
(43) Pub. Date: Mar. 29, 2007

(54) Imaged Watermark in a Credential Product

(75) Inventors: Karl A. Karst, Woodbury, MN (US); D. Alan Fontanella, Plymouth, MN (US); Gary M. Klinefelter, Eden Prairie, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Fargo Electronics, Inc., Eden Prairie, MN (US)

(21) Appl. No.: 11/535,321

(22) Filed: Sep. 26, 2006

Related U.S. Application Data
(60) Provisional application No. 60/720,906, filed on Sep. 27, 2005.

(51) Int. Cl. H04L 9/32

(52) U.S. Cl. 726/5

(57) ABSTRACT

A credential product is provided. The credential product includes a credential substrate, a translucent layer and an imageable layer. The imageable layer is positioned between the credential substrate and the translucent layer. At least a portion of the imageable layer is configured to form an image upon exposure to electromagnetic radiation. The image is visible through the credential substrate and is considered an imaged watermark.

The present application is based on and claims the benefit of U.S. provisional patent application Ser. No. 60/720,906, filed Sep. 27, 2005, the content of which is hereby incorporated by reference in its entirety.

### FIELD OF THE INVENTION

The present invention is generally directed to a credential product More particularly, the present invention is directed to a security mark or watermark formed in a credential product for purposes of verifying the authenticity of the credential product.

### BACKGROUND OF THE INVENTION

Credential products include, for example, identification cards, driver's licenses, passports, and other valuable documents. Such credentials are formed from credential substrates including paper substrates, plastic substrates, card bodies and other materials. Such credentials generally include printed information on a surface of the credential product, such as a photo, account numbers, identification numbers, and other personal information. Personal information printed on a surface of a credential product is printed using a print consumable, such as ink and ribbon.

Security features and security marks can be formed in a credential product to validate the authenticity of the credential product, such as an identification card and other types of cards, where counterfeit protection is desired. One such security feature or security mark is a watermark. One example of a watermark is an imaged watermark that is viewable in transmitted light and can be less viewable or completely invisible in reflected light.

Imaged watermarks are generally buried within a credential product and are commonly used as security features for identification cards, currency and other documents of value. In one typical application, an imaged watermark is placed in a standard location on a document of value. A person can verify the authenticity of the document by looking for the presence of the imaged watermark in the correct location on the document. In another typical application, an imaged watermark is continuously repeated at a given interval (i.e., in a “wallpaper” format) within a document of value and is not positioned in any particular location within the document. A person can verify the authenticity of the document by looking for the presence of the continuously repeated imaged watermark. In these typical imaged watermark applications, the image of the watermark is the same within a set amount credential products.

A more secure credential product than a credential product that includes an imaged watermark that is the same within a set amount of credential products includes a watermark that relates to and is specific to the personal information printed on the surface of the credential product. One example technique includes the forming of a unique digital watermark in a credential product. This technique requires the digital imaging of a card member and the subsequent lamination of individual card members. Another example technique includes the embedding of information within a credential product by electronically encoding data on an embedded chip. The encoded information can be read by a reader and then compared against personal information printed on the surface of the credential product for purposes of authentication. These example techniques are both complex techniques and costly techniques. Therefore, there is a need to develop a simplified and a cost effective credential product including a watermark that relates to and is specific to the personal information printed on the surface of the credential product.

Embodiments of the present invention provide solutions to these and other problems, and offer other advantages over the prior art.

### SUMMARY OF THE INVENTION

Embodiments of the disclosure include a credential product as well a method of forming an imaged watermark. Embodiments of the credential product include a card or credential substrate, an imageable layer and a translucent layer. The imageable layer is positioned between the card substrate and the translucent layer. At least a portion of the imageable layer is configured to form an image upon exposure to electromagnetic radiation. The image is visible through the card substrate and is considered an imaged watermark. In other embodiments, portions of the imageable layer are exposed to electromagnetic radiation and are configured to change from a first level of opacity to a second level of opacity to form an image.

Embodiments of the method of forming an imaged watermark include forming a credential product that includes an imageable layer positioned between a card substrate and a translucent layer. Electromagnetic radiation is then applied to the imageable layer such that the imageable layer changes from a first level of opacity to a second level of opacity to form an image.

### BRIEF DESCRIPTION OF THE DRAWINGS

FIG. 1 is simplified sectional view of a credential product.

FIG. 2 is a flowchart illustrating a method of forming an imaged watermark in a credential product.

FIGS. 3 and 4 illustrate a simplified sectional views of a sheet for forming credential products in accordance with the flowchart illustrated in FIG. 2.

FIG. 5 illustrates a simplified sectional view of a credential product as formed in accordance with the flowchart illustrated in FIG. 2 FIG. 6 is a simplified sectional view of a credential product in the presence of reflected light.

FIG. 7 is a simplified sectional view of a credential product in the presence of transmitted light.

FIG. 8 is a simplified sectional view of a credential product as formed in accordance with the flowchart illustrated in FIG. 2.

### DETAILED DESCRIPTION OF THE PREFERRED EMBODIMENTS

Embodiments of the disclosure provide security from counterfeiting of card-type credential products. Card-type credential products, such as identification cards or other valuable cards issued to individuals (i.e., drivers' licenses, credit cards and etc), include personalized printed information on a surface of the credential product, such as a photograph, account numbers, identification numbers, and other personal information. Embodiments of the disclosure provide security in the form of a security imaged mark or imaged watermark that is related to or is specific to the personal information printed on the surface of the credential product. An imaged watermark includes an image or pattern that is generally buried in layers of a document, which is visible in transmitted light and is less visible or invisible in reflected light.

It is possible that an imaged watermark in a card-type credential product can be formed by printing an image using inkjet printing, dye sublimation or other form of printing and then subsequently burying the image within the body of a card-type credential product. Such a process of forming an imaged watermark requires that the card printing and forming device laminate or bond individual card members together. This process adds significant complexity and cost to a card issuing system. Therefore, embodiments of the disclosure pertain to a card-type credential product that includes the formation of an imaged watermark without the significant cost and complexity of printing and laminating individual card members at the time of card issue.

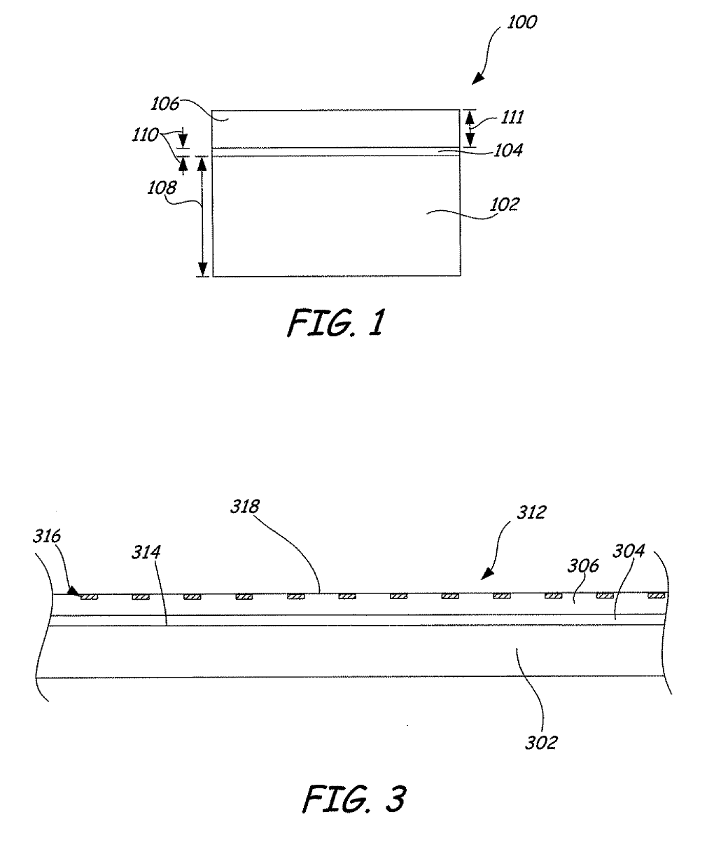

FIG. 1 illustrates a credential product 100. Credential product 100 includes a card substrate or card body 102, an imageable layer 104 and a translucent layer 106. Card substrate 102 is a translucent substrate. The translucency of card substrate 102 can vary depending on the amount of pigment particles (e.g., titanium dioxide—TiO₂) that is loaded into card substrate 102. For example, when keeping a thickness 108 of a card substrate constant, a lower amount of pigment particles loaded into card substrate 102 provides a greater transmission of light (i.e., visible light), while a high amount of pigment particles loaded into card substrate 102 provides less of a transmission of light. Generally, thickness 108 of card substrate 102 can range from between 10 and 35 mils. Typically, thickness 108 of card substrate 102 ranges between 25 and 30 mils.

Imageable layer 104 is a material that is sensitive to electromagnetic radiation or photons, which are constituents of electromagnetic radiation. For example, imageable layer 104 can be sensitive to infrared radiation (i.e., can absorb infrared radiation). An imageable layer that is sensitive to infrared radiation can include a layer of vinyl overlay film available from Klockner-Pentaplast of Gordonsvile, Va. that is coated with an infrared absorbing dye available from H. W. Sands Corp. of Jupiter, Fla. and other components, such as resins. In another example, imageable layer 104 can be sensitive to laser radiation. Imageable layer 104 that is sensitive to laser radiation can include photo-reactive chemistries used in formulating the imageable layer. Such chemistries are available from DataLase, Ltd. of Wildnes, Cheshire (UK).

Portions of imageable layer 104 that are exposed to electromagnetic radiation are configured to change from a first level of opacity to a second level of opacity to form an image. The first level of opacity is less than the second level of opacity. Therefore, before exposure to electromagnetic radiation, portions of imageable layer 104 allow for more transmission of light than after exposure to electromagnetic radiation when portions of the photo-reactive layer allows for less transmission of light. In the example where imageable layer 104 is sensitive to infrared radiation, portions of the imageable layer will typically change from a slightly off-white color or clear to a black or brown color when exposed to specific absorbing wavelengths. In the example where imageable layer 104 is sensitive to laser radiation, portions of the photo-reactive layer will typically change from clear to a black color or other dark color when exposed to specific wavelengths of laser radiation. Generally, imageable layer 104 has a thickness 110 that can vary from less than 1 micron to as much as approximately 10 microns. Typically, thickness 110 of imageable layer 104 ranges between 1 and 2 microns.

Translucent layer 106 includes a translucent material. In one example, translucent material 106 can be a polyvinyl chloride film. The translucency of the polyvinyl chloride film can vary depending on the amount of pigment particles (e.g., titanium dioxide—TiO₂) that are incorporated into the film. While keeping a thickness of the film constant, a lower amount of pigment particles incorporated into the film provides a greater transmission of light (i.e., visible light), while a high amount of pigment particles incorporated into the film provides less of a transmission of light. Generally, a translucent layer 106 has a thickness 111 between approximately 1 and 20 mils when translucent layer 106 is a polyvinyl chloride film.

In another example, translucent layer 106 can be a layer of printed material, such as a layer of ink or printed film. Such a layer of printed material includes a similar translucency as that in a polyvinyl chloride film. However, a layer of printed material will allow electromagnetic radiation to scatter at a lesser degree than that allowed by the polyvinyl chloride film when imageable layer 104 is exposed to electromagnetic radiation. A lesser degree of scatter provides imageable layer 104 with an image that is formed with a higher resolution compared to that which can be formed when credential product 100 includes a polyvinyl chloride film. Generally, thickness 111 of translucent layer 106 is approximately less than 1 mil when translucent layer 106 is a layer of printed material. Typically thickness 111 of translucent layer 106 is between 0.1 and 0.5 mils when translucent layer 106 is a layer of printed material.

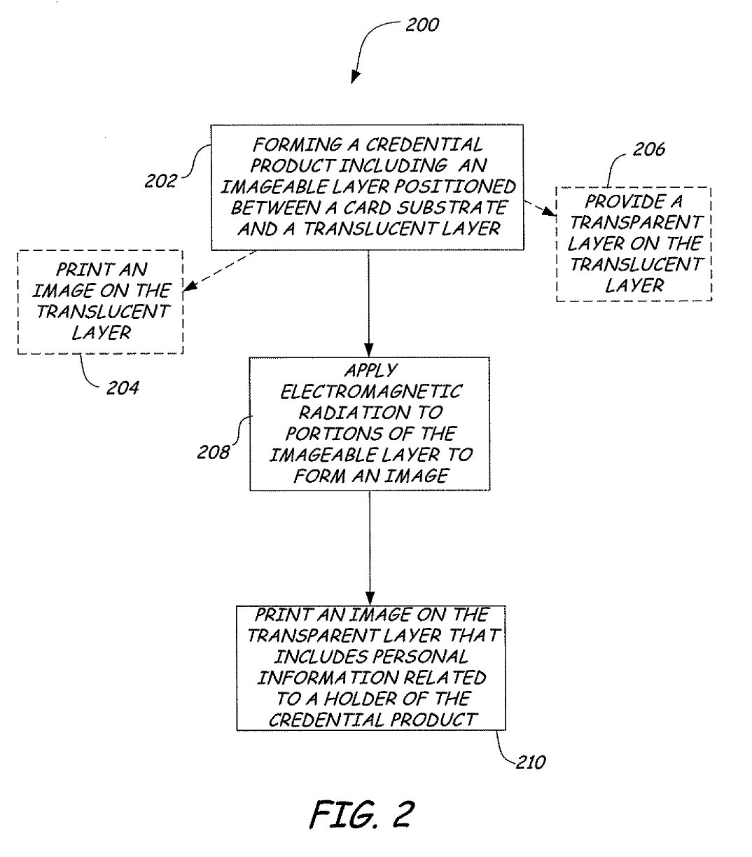

FIG. 2 illustrates a method 200 of forming an imaged watermark in a card-type credential product in accordance with embodiments of the disclosure. The imaged watermark formed in method 200 is only highly visible in transmitted light (i.e., light passing through the card) and is not, or is only minimally visible in reflected light. FIG. 2 also illustrates other optional method steps that can be performed in method 200. These optional method steps are indicated in dashed lines.

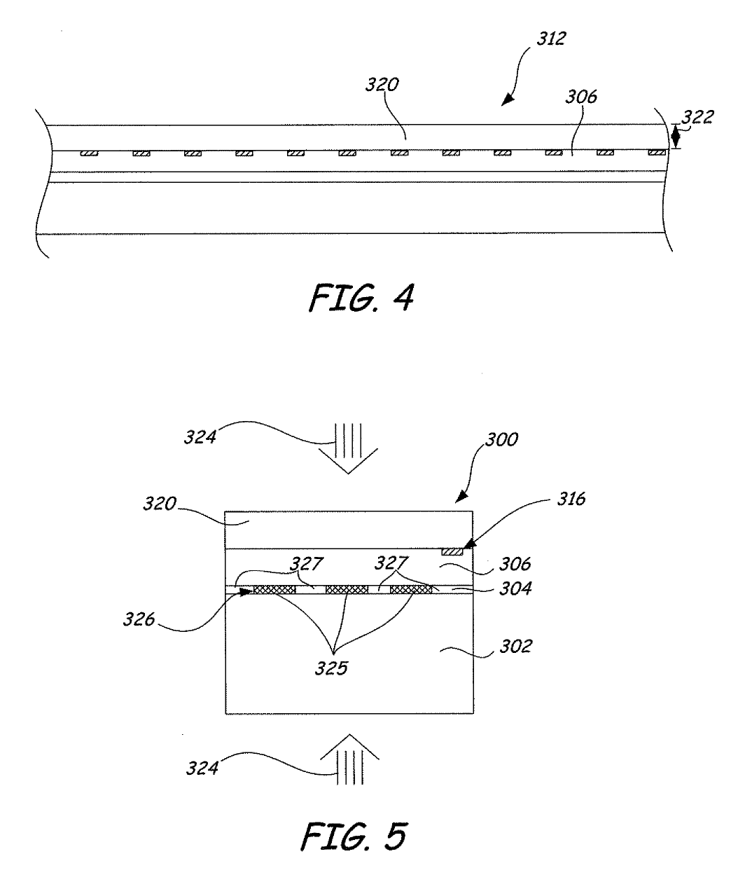

At step 202, a credential product is formed that includes an imageable layer positioned between a card substrate and a translucent layer. A credential product can be formed in a variety of ways. In one way, and as illustrated exemplary in FIGS. 3 and 4, a large sheet 312 is formed that includes a card substrate 302, an imageable layer 304 and a translucent layer 306. The large sheet allows many credential products to be easily formed and manufactured simultaneously by forming various layers and cutting individual credential products from the large sheet. It should be understood that credential products can also be formed on an individual basis using step 202 in method 200.

There are many different steps in which credential products can be formed in either a large sheet, such as large sheet 312, or on an individual basis. In one embodiment, imageable layer 304 can be provided. The imageable layer 304 is applied to card substrate 302 and translucent layer 306 is then applied to imageable layer 304. This method is generally accomplished by a screen printing or other types of techniques. In another embodiment, imageable layer 304 is provided and the imaged layer 304 is applied to translucent layer 306. Together, imageable layer 304 and translucent layer 306 are applied to card substrate 302. This method is generally accomplished by gravure, roll coating, knife coating, rotary screen printing or other types of techniques.

In addition, there are many optional steps that can be performed in the forming of a credential product. For example, FIG. 2 illustrates optional step 204 where an image 316 is printed on the translucent layer 306. As illustrated on a large sheet 312 in FIG. 3, image 316 includes a plurality of individual images that are the same and are continuously repeated over surface 318 of translucent layer 306. Each repeated image will be included in each credential product when large sheet 312 is cut apart. Image 316 can be printed with pigmented inks or dye-based inks and is considered to be a “pre-printed” image since it is printed prior to each credential product being cut from large sheet 312 or individual credential products being fully formed. Typically, image 316 is a company logo or other type of similar image that can be included across a set amount of credential products.

In another example, FIG. 2 illustrates optional step 206 where a transparent layer 320 is provided on translucent layer 306 as illustrated in FIG. 4. Transparent layer 320 is a clear layer of material that is typically a clear polyvinyl chloride overlay. Generally, transparent layer 320 has a thickness 322 that can vary from less than 1 to as much as 10 mils. Typically, thickness 322 of transparent layer 320 ranges between 1 and 3 mils.

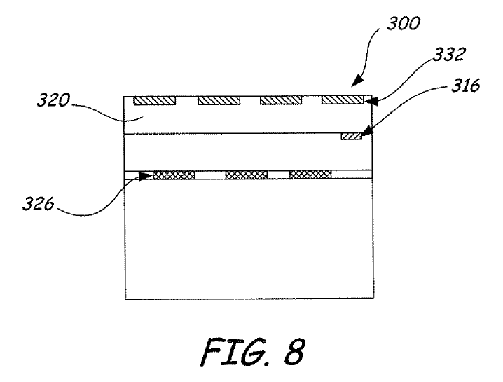

After a credential product is formed and separated by cutting individual credential products from large sheet 312 or by forming an individual credential product, each individual credential product is ready to undergo further processing in steps 208 and 210. An example credential product 300 formed using steps 208 and 210 is illustrated in FIGS. 5 and 8. Although FIGS. 5 and 8 illustrate optional “pre-printed” image 316 and transparent layer 320, it should be understood that credential product 300 need not include such features and disclosed embodiments are not limited to such features.

At step 208, electromagnetic radiation 324 is applied to portions 325 of photo-reactive layer 304 to form an image 326. As illustrated in FIG. 5, electromagnetic radiation 324 can either be passed through transparent layer 320 and translucent layer 306 or can be passed through card substrate 302 to form image 326. As previously discussed, portions 325 of imageable layer 304 change from a first level of opacity to a second level of opacity to form an image. After credential product 300 has undergone the process in step 208, imageable layer will have portions 325 that have a second level of opacity and remaining portions 327 that have a first level of opacity. As also previously discussed, the first level of opacity is less than the second level of opacity. Therefore, portions 325 that have a second level of opacity allow for less transmission of visible light than remaining portions 327.

Image 326 is an imaged watermark. Imaged watermark 326 can include personal information related to the holder of credential product 300. For example, imaged watermark 326 can include an image of the holder's name, a photograph of the holder and other related personal information of the holder. Imaged watermark 326 can also include information that corresponds with a chip contained in card substrate 302 in the case of a contact or contactless smart card.

Referring to credential product 300 of FIG. 5, image 326 can be described as an imaged watermark in a credential product that is not easily visible in reflected light, but easily visible in transmitted light. For example, FIG. 6 illustrates credential product 300 and reflected visible light. As illustrated, since layer 306 is a translucent layer, a portion of visible light 328 can be reflected by translucent layer 306 and another portion of visible light 330 can be reflected by image 326 because of its higher level of opacity. Therefore, when viewing credential product 300 from above, it is possible that, depending on the degree of translucency of translucent layer 306 and the optical density of image 326, image 326 can be completely invisible or can be partially visible as a “ghost-like” image. A slight change in optical density of image 326 compared to its background (i.e., 0.10 for image 326 vs. 0.08 for the background) can be enough to allow a “ghost-like” image to be visible rather than completely invisible. While, by varying the degree of translucency of translucent layer 306, the “ghost-like” image can vary to be more or less visible. The degree of translucency for translucent layer 306 varies by changing the thickness of translucent layer 306 or by changing the amount of pigment particles (e.g., TiO₂) in translucent layer 306.

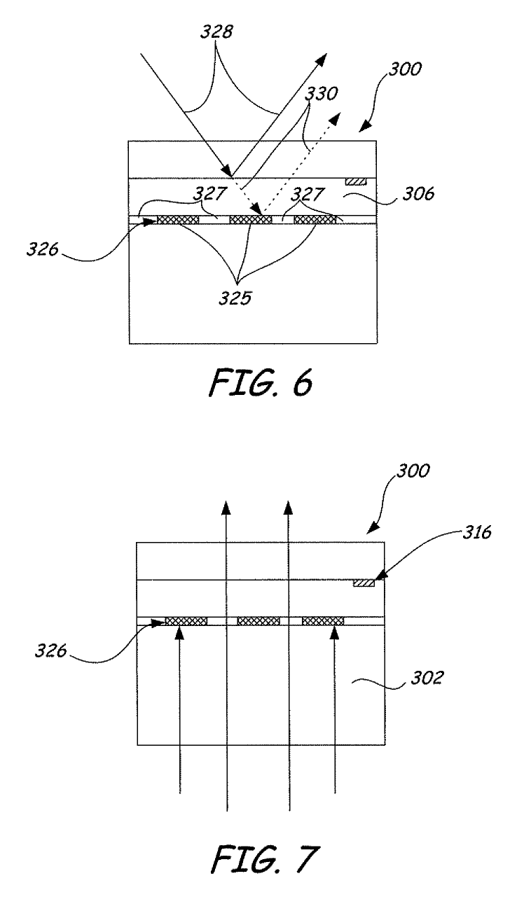

In another example, FIG. 7 illustrates credential product 300 and transmitted visible light. As illustrated, the translucency of card substrate 302 allows for some transmission of visible light. Typically card substrates, such as card substrate 302, will show light transmission of up to 10% over the visible light wavelength range, which is approximately 400-700 nm. In other words, light transmission that is measured at a specific wavelength may vary from 0-10% depending on the wavelength at which the light transmission is measured. The imaged watermark, such as image 326, tends to become visible through card substrate 302 when the light transmission decreases at the center of the visible light wavelength range, which is approximately 550 nm, by as little as 5%. Imaged watermark 326 tends to become easily visible through card substrate 302 when image 326 decreases light transmission from 30% to 100% over the visible light wavelength range.

In reference to both FIGS. 2 and 8, at step 210, an image 332 is printed on transparent layer 320 using any conventional technique for printing card-type credential products, such as ink-jet, dye sublimation and thermal transfer techniques. Image 332 is a personalized image that can include photographs, biographical information, barcodes and/or other decorative elements. Personalized image 332 is specific to and related to imaged watermark 326 which is buried within the card-type credential product 300 and is related to the holder of credential product 300. Although step 210 is illustrated as taking place after applying electromagnetic radiation to the formed credential product, it should be understood that printing a personalized image on transparent layer 320 can also be done prior to applying electromagnetic radiation to the formed credential product.

Although the present invention has been described with reference to preferred embodiments, workers skilled in the art will recognize that changes may be made in form and detail without departing from the spirit and scope of the invention.

What is claimed is:

1. A credential product comprising:
a card substrate;
a translucent layer; and
an imageable layer positioned between the card substrate and the translucent layer,
wherein portions of the imageable layer are exposed to electromagnetic radiation and are configured to change from a first level of opacity to a second level of opacity to form an image.

2. The credential product of claim 1, wherein the card substrate is translucent.

3. The credential product of claim 1, wherein the first level of opacity is less than the second level of opacity.

4. The credential product of claim 1, wherein the imageable layer comprises a photo-reactive chemistry that changes the imageable layer from the first level of opacity to the second level of opacity upon exposure to laser radiation.

5. The credential product of claim 1, wherein the imageable layer comprises an infrared absorbing material that changes the imageable layer from the first level of opacity to the second level of opacity upon exposure to infrared radiation.

6. The credential product of claim 1, wherein the translucent layer is configured to receive a printed image.

7. The credential product of claim 1, wherein the translucent layer formed on the top surface of the imageable layer comprises printed material.

8. The credential product of claim 1, wherein the translucent layer comprises a polyvinyl chloride film.

9. The credential product of claim 1, further comprising a transparent layer positioned on the translucent layer.

10. The credential product of claim 9, wherein the transparent layer is configured to receive a printed image.

11. The credential product of claim 10, wherein the printed image received by the transparent layer comprises a personalized printed image containing personal information related to a holder of the credential product.

12. The credential product of claim 11, wherein the personalized printed image received by the transparent layer corresponds with the image formed in the imageable layer.

13. A method of forming an imaged watermark comprising:
forming a credential product that includes an imageable layer positioned between a card substrate and a translucent layer; and
applying electromagnetic radiation to the imageable layer such that the imageable layer changes from a first level of opacity to a second level of opacity to form an image.

14. The method of claim 13, further comprising providing a transparent layer on the translucent layer.

15. The method of claim 13, further comprising printing an image on the transparent layer that corresponds with the image formed in the imageable layer.

16. The method of claim 13, wherein the card substrate comprises a translucent material that allows transmission of visible light such that the image formed in the imageable layer is visible through the card substrate.

17. The method of claim 13, wherein the translucent layer comprises a translucent material that reflects and transmits visible light such that the image formed in the photo-reactive layer is completely invisible to at least partially visible.

18. A credential product comprising:
a credential substrate;
a translucent layer; and
an imageable layer positioned between the credential substrate and the translucent layer,
wherein at least a portion of the imageable layer is configured to form an image upon exposure to electromagnetic radiation, the image being visible through the card substrate.

19. The credential product of claim 18, wherein the imageable layer comprises a material configured to change from a first level of opacity to a second level of opacity upon exposure to laser radiation.

20. The credential product of claim 19, wherein the portion of the imageable layer that forms the image changes from the first level of opacity to the second level of opacity upon exposure to laser radiation.
